(19) United States
(12) Patent Application Publication
(10) Pub. No.: US 2024/0093479 A1
(43) Pub. Date: Mar. 21, 2024

(54) INTERWOVEN LATTICE STRUCTURE AND METHOD FOR DESIGNING ULTRA-COMPLIANT INTERWOVEN META-MATERIALS

(71) Applicants: Yash Mistry, Tempe, AZ (US); Siying Liu, Gilbert, AZ (US); Mandar Shinde, Tempe, AZ (US); Xiangfan Chen, Chandler, AZ (US); Dhruv Bhate, Scottsdale, AZ (US); Nikhilesh Chawla, West Lafayette, IN (US); Swapnil Morankar, West Lafayette, IN (US); Clint Penick, Kennesaw, GA (US)

(72) Inventors: Yash Mistry, Tempe, AZ (US); Siying Liu, Gilbert, AZ (US); Mandar Shinde, Tempe, AZ (US); Xiangfan Chen, Chandler, AZ (US); Dhruv Bhate, Scottsdale, AZ (US); Nikhilesh Chawla, West Lafayette, IN (US); Swapnil Morankar, West Lafayette, IN (US); Clint Penick, Kennesaw, GA (US)

(21) Appl. No.: 18/468,185

(22) Filed: Sep. 15, 2023

Related U.S. Application Data
(60) Provisional application No. 63/375,808, filed on Sep. 15, 2022.

(51) Int. Cl. E04B 1/19; B29C 64/182

(52) U.S. Cl. CPC E04B 1/19; B29C 64/182; B33Y 10/00

(57) ABSTRACT

A unit cell of an interwoven lattice structure having an interwoven point therein. The unit cell includes first, second, third, and fourth struts each having an interwoven node offset from the interwoven point. The first strut has a first interwoven node offset from a first diagonal unit cell plane in a first distance and first direction. The second strut has a second interwoven node offset from the first diagonal unit cell plane in a second distance and second direction opposite the first direction. The third strut has a third interwoven node offset from a second diagonal unit cell plane in a third distance and third direction. The fourth strut has a fourth interwoven node offset from the second diagonal unit cell plane in a fourth distance and fourth direction opposite the third direction. The first and second diagonal unit cell planes both pass through the interwoven point.

### CROSS-REFERENCE TO RELATED APPLICATIONS

This application claims priority to co-pending U.S. Provisional Patent Application No. 63/375,808 filed on Sep. 15, 2022, the entire contents of which are incorporated herein by reference.

### STATEMENT REGARDING FEDERALLY SPONSORED RESEARCH OR DEVELOPMENT

This invention was made with government support under 80NSSC20C0021 awarded by the National Aeronautical & Space Administration. The government has certain rights in the invention.

### FIELD

The present disclosure generally relates to lattice structures.

### BACKGROUND

The advent of additive manufacturing has seen an explosive growth in the use of the technology to fabricate structures that have enhanced performance in a wide range of applications. One such family of structures is called cellular, or meta-materials, examples of which are honeycombs, foams and lattices. These materials enable novel properties that exploit the nature of the design of the structure, as opposed to just the original material itself.

### SUMMARY

The disclosure provides, in one aspect, a unit cell of an interwoven lattice structure, the unit cell having an interwoven point therein, the unit cell including a first strut, a second strut, a third strut, and a fourth strut. The first strut has a first interwoven node offset from a first diagonal unit cell plane by a first distance in a first direction perpendicular to the first diagonal unit cell plane. The second strut has a second interwoven node offset from the first diagonal unit cell plane by a second distance in a second direction opposite to the first direction. The third strut has a third interwoven node offset from a second diagonal unit cell plane by a third distance in a third direction perpendicular to the second diagonal unit cell plane. The second diagonal unit cell plane is perpendicular to the first diagonal unit cell plane. The fourth strut has a fourth interwoven node offset from the second diagonal unit cell plane by a fourth distance in a fourth direction opposite to the third direction. Each of the first interwoven node, second interwoven node, third interwoven node, and the fourth interwoven node are offset from the interwoven point of the unit cell. The first diagonal unit cell plane and the second diagonal unit cell plane both pass through the interwoven point.

The disclosure provides, in another aspect, a method of altering a nodally coupled base unit cell to model a nodally decoupled unit cell model, the method including modelling the base unit cell, the base unit cell including a first strut and a second strut which intersect at a nodal intersection point, identifying the nodal intersection point, and decoupling the first strut from the second strut by moving a node of the first strut a first distance in a first direction away from the nodal intersection point.

The disclosure provides, in another aspect, a method for manufacturing an interwoven lattice structure, the method including a first nodally decoupled unit cell having at least two struts interwoven with one another, the first nodally decoupled unit cell having a first unit cell boundary, constructing a second nodally decoupled unit cell having at least two struts interwoven with one another, the second nodally decoupled unit cell having a second unit cell boundary, coupling, at an interface between the first unit cell boundary and the second unit cell boundary, the first nodally decoupled unit cell to the second nodally decoupled unit cell

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 illustrates a standard body centered cubic lattice structure.

FIG. 2A illustrates a standard body centered cubic unit cell.

FIG. 2B illustrates a first strut and a second strut of the standard body centered cubic unit cell of FIG. 2A.

FIG. 2C illustrates a third strut and a fourth strut of the standard body centered cubic unit cell of FIG. 2A.

FIG. 3A illustrates an interwoven body centered cubit unit cell.

FIG. 3B illustrates a first strut and a second strut of the interwoven body centered cubic unit cell of FIG. 3A.

FIG. 3C illustrates a third strut and a fourth strut of the interwoven body centered cubit unit cell of FIG. 3A.

FIG. 4 illustrates an interwoven body centered cubic lattice structure.

FIG. 5 is a load displacement graph of a standard body centered cubic lattice structure in comparison with an interwoven body centered cubic lattice structure.

FIG. 6 is a compliance graph of a standard body centered cubic lattice structure in comparison with an interwoven body centered cubic lattice structure.

FIG. 7 is a normalized effective modulus-relative density graph of a standard body centered cubic lattice structure in comparison with an interwoven body centered cubic lattice structure.

FIG. 8 is a flow chart illustrating a method of altering a base unit cell model to model a nodally decoupled unit cell model.

FIG. 9 is a flow chart illustrating a method of manufacturing an interwoven lattice structure.

FIG. 10 illustrates an additive manufacturing system.

FIG. 11 illustrates a plurality of additional nodally coupled unit cells and a hybridized FCC-BCC lattice.

FIG. 12 illustrates a plurality of exemplary nodally decoupled unit cells and a hybridized nodally decoupled interwoven-FCC-interwoven-BCC lattice.

Before any examples are explained in detail, it is to be understood that the disclosure is not limited in its application to the details of construction and the arrangement of components set forth in the following description or illustrated in the drawings. The disclosure is capable of other examples and of being practiced or of being carried out in various ways. Also, it is to be understood that the phraseology and terminology used herein is for the purpose of description and should not be regarded as limiting.

### DETAILED DESCRIPTION

Compliance is the inverse of stiffness, and is a measure of the flexibility of a structure. For a given material composition, compliant structures are typically derived through one of three approaches: (i) metamaterial design, (ii) computational design and topology optimization methods, or (iii) mechanisms such as joints.

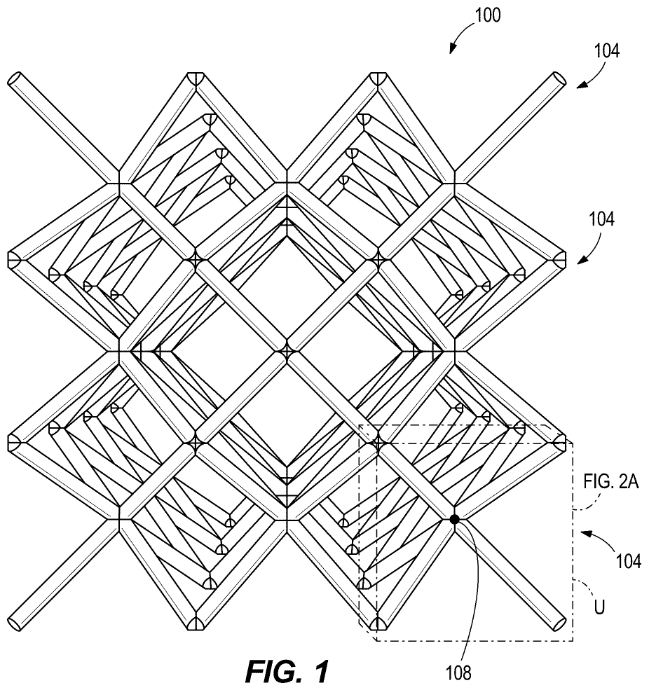

FIG. 1 illustrates a standard body centered cubic (BCC) lattice structure 100 including a plurality of standard BCC unit cells 104 coupled to one another. Each BCC unit cell 104 is centered about a centroid 108.

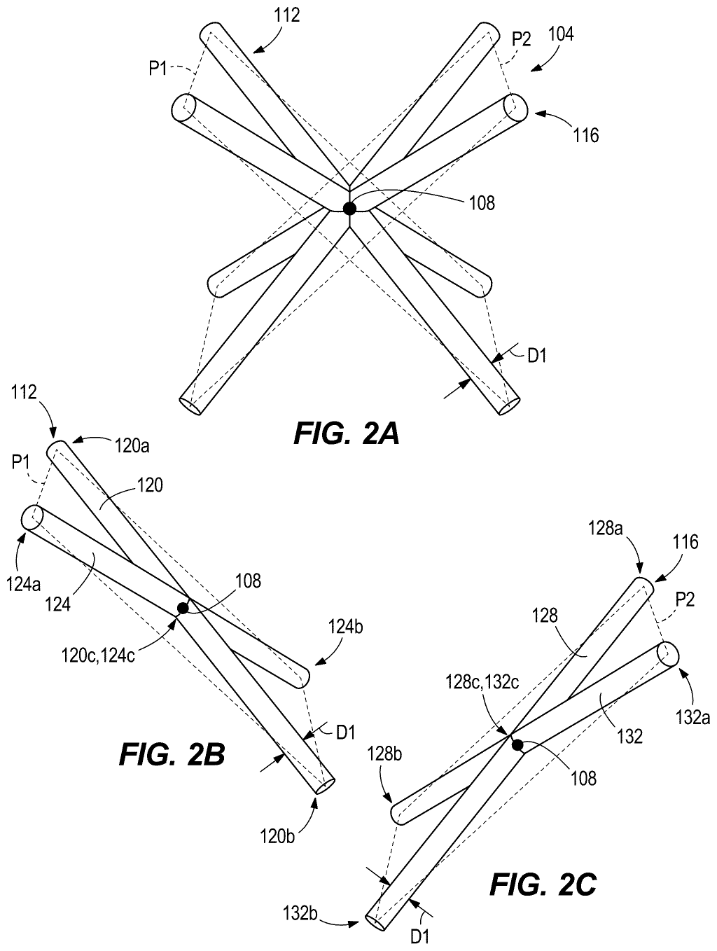

FIGS. 2A-2C illustrate one BCC unit cell 104. The BCC unit cell 104 may be conceptually separated into a first BCC segment 112 which is oriented along a first diagonal unit cell plane P1 and a second BCC segment 116 which is oriented along a second diagonal unit cell plane P2. In the BCC lattice structure, the centroid 108 is centrally located within the boundaries of the BCC unit cell 104, and both the first diagonal unit cell plane P1 and the second diagonal unit cell plane P2 pass through the centroid 108. As illustrated in FIGS. 2B-2C, each BCC segment 112, 116 includes two struts. The first BCC segment 112 includes struts 120, 124, and the second BCC segment 116 includes struts 128, 132. Each strut 120, 124, 128, 132 is generally tubular in shape, and extends between corners of the BCC unit cell 104. The BCC unit cell 104 is represented by the struts 120, 124, 128, 132, which are positioned within and bounded by an overall BCC unit cell 104 (also referenced as unit cell “U” in FIG. 1) having three dimensions. The illustrated BCC unit cell 104 is generally cubic.

With continued reference to FIGS. 2A-2C, each strut 120, 124, 128, 132 includes a thickness D1. In the illustrated example, each strut 120, 124, 128, 132 has a cross-sectional shape taken perpendicularly to the strut 120, 124, 128, 132 which is generally circular. In such an example, the thickness D1 may be a diameter. However, in other examples, the cross-sectional shape of the struts 120, 124, 128, 132 may differ (e.g., may be square, or other shapes).

In the illustrated example, each strut 120, 124, 128, 132 also has a first end 120a, 124a, 128a, 132a, a second end 120b, 124b, 128b, 132b opposite the first end 120a, 124a, 128a, 132a, and a central point 120c, 124c, 128c, 132c between the first and second ends 120a, 124a, 128a, 132a, 120b, 124b, 128b, 132b. The central points 120c, 124c, 128c, 132c are coincident with the centroid 108. As such, the standard BCC unit cell 104 is a nodally coupled unit cell. Each of the first ends and second ends 120a, 124a, 128a, 132a, 120b, 124b, 128b, 132b terminates at a corner of the standard BCC unit cell 104. As such, the standard BCC unit cell 104 may be described as having boundary periodicity such that the standard BCC unit cell 104 may be duplicated in an array (e.g., three-dimensional grid), with one BCC unit cell 104 being coupled to at least one adjacent BCC unit cell 104 such as in the standard BCC lattice structure 100.

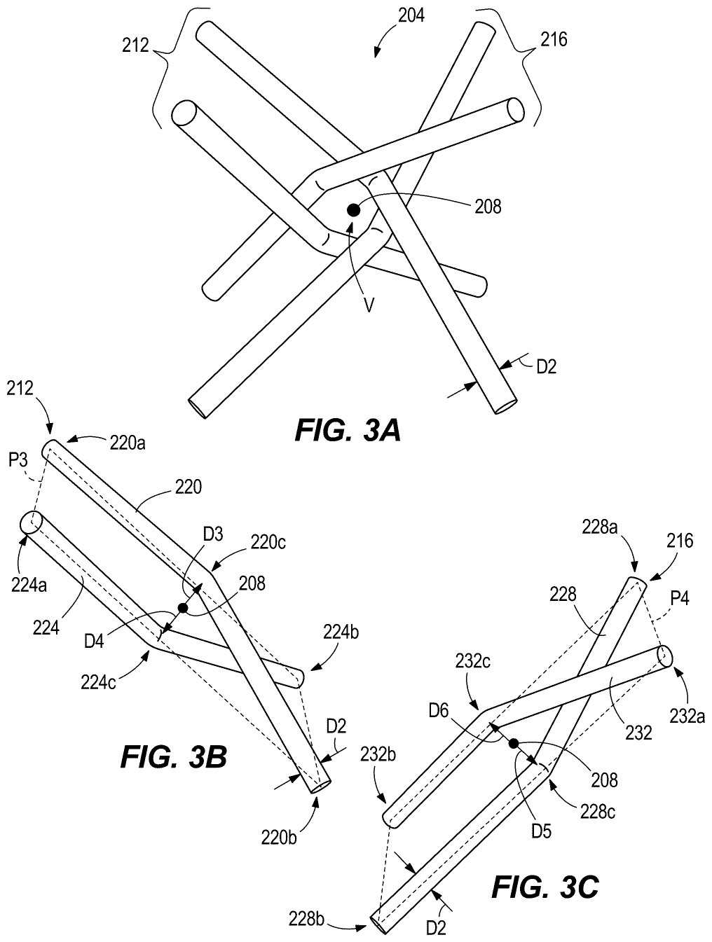

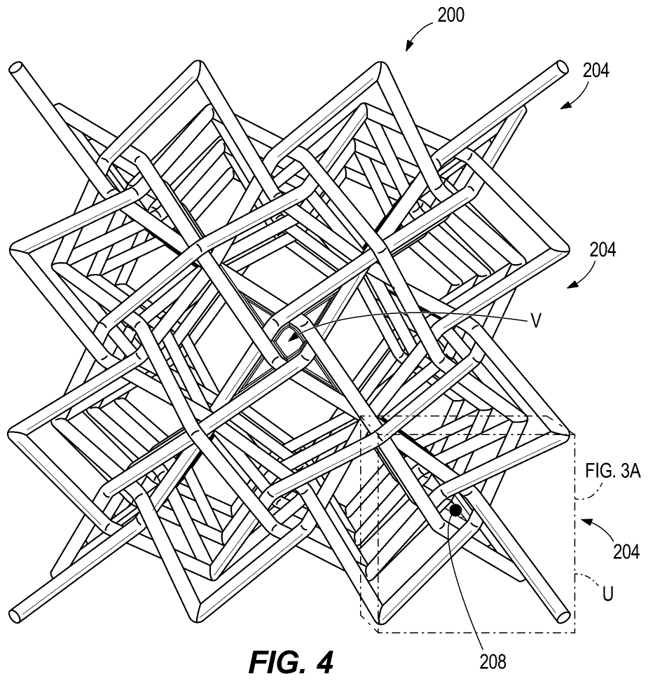

FIGS. 3A-3C illustrate an interwoven body centered cubic (i-BCC) unit cell 204. The i-BCC unit cell 204 is centered about an interwoven point 208 (e.g., a point in space). As illustrated in FIGS. 3B-3C, the i-BCC unit cell 204 may be further separated into a first i-BCC segment 212 which is oriented along a first diagonal unit cell plane P3 and a second i-BCC segment 216 which is oriented along a second diagonal unit cell plane P4. Both the first diagonal unit cell plane P3 and the second diagonal unit cell plane P4 pass through the interwoven point 208. Each i-BCC segment 212, 216 includes two struts. The first i-BCC segment 212 includes struts 220, 224, and the second i-BCC segment 216 includes struts 228, 232. Each strut 220, 224, 228, 232 is generally tubular in shape, and extends between corners of the i-BCC unit cell 204. The i-BCC unit cell 204 is represented by the struts 220, 224, 228, 232, which are positioned within and bounded by an overall i-BCC unit cell 204 (also referenced as unit cell “U” in FIG. 4) having three dimensions. The illustrated i-BCC unit cell 204 is generally cubic.

Each strut 220, 224, 228, 232 includes a thickness (e.g., diameter) D2. In the illustrated example, each strut 220, 224, 228, 232 has a cross-sectional shape taken perpendicularly to the strut 220, 224, 228, 232 which is generally circular. In such an example, the thickness D2 may be a diameter. However, in other examples, the cross-sectional shape of the struts 220, 224, 228, 232 may differ (e.g., may be square, or other shapes).

In the illustrated example, each strut 220, 224, 228, 232 has a first end 220a, 224a, 228a, 232a, a second end 220b, 224b, 228b, 232b opposite the first end 220a, 224a, 228a, 232a, and an interwoven node 220c, 224c, 228c, 232c between the first and second ends 220a, 224a, 228a, 232a, 220b, 224b, 228b, 232b. In some examples, the interwoven nodes 220c, 224c, 228c, 232c represent points or locations along the struts 220, 224, 228, 232 where the struts 220, 224, 228, 232 change direction (e.g., where the struts 220, 224, 228, 232 bend). In the illustrated example, each node 220c, 224c, 228c, 232c is spaced from the interwoven point 208 by a distance D3, D4, D5, or D6. The first strut 220 has a first interwoven node 220c which is offset from the interwoven point 208 (the interwoven point 208 being positioned on both the first diagonal unit cell plane P3 and the second diagonal unit cell plane P4) by a distance D3. In some examples, this distance D3 is measured in a first direction perpendicular to, or at an oblique angle to, the first diagonal unit cell plane P3. The second strut 224 has a second interwoven node 224c which is offset from the interwoven point 208 by a distance D4. In some examples, this distance D4 is measured in a second direction perpendicular to, or at an oblique angle to, the first diagonal unit cell plane P3. In some examples, the second direction is measured opposite to the first direction. The third strut 228 has a third interwoven node 228c which is offset from the interwoven point 208 by a distance D5. In some examples, this distance D5 is measured in a third direction perpendicular to, or at an oblique angle to, the second diagonal unit cell plane P4. The fourth strut 232 has a fourth interwoven node 232c which is offset from the interwoven point 208 by a distance D6. In some examples, this distance D6 is measured in a fourth direction perpendicular to, or at an oblique angle to, the second diagonal unit cell plane P4. In some examples, the fourth direction is measured opposite to the third direction.

Due to the location of the nodes 220c, 224c, 228c, 232c, the struts 220, 224, 228, 232 do not intersect one another, but rather become interwoven with one another, and the i-BCC unit cell 204 may be defined as a nodally decoupled unit cell. The nodes 220c, 224c, 228c, 232c are each spaced from one another such that none of the struts 220, 224, 228, 232 pass through the interwoven point 208, and a void V (FIG. 3A) is present at the interwoven point 208.

In the i-BCC unit cell 204, ends (e.g., the first end 220a and the second end 220b) of a single strut (e.g., the first strut 220) traverse the i-BCC unit cell 204 between opposing corners thereof without intersecting the interwoven point 208. However, in other examples, it is possible that one of the struts, for example, the first strut 220, includes a node (not illustrated) coincident with the interwoven point 208. In such an example, to form the nodally decoupled unit cell, the remaining struts would be spaced from the interwoven point 208.

Also, in other examples (not shown), it is possible that a single strut (e.g., a modified first strut 220) may include two or more intermediate nodes between the first end 220a and the second end 220b—where the two or more intermediate nodes are spaced from an imaginary diagonal strut line between corners of the i-BCC unit cell 204 located by the first end 220a and the second end 220b of the strut 220. Optionally, the single strut (e.g., the modified first strut 220) may include nodes which define segments which are coincident with the imaginary diagonal strut line.

In the illustrated i-BCC unit cell 204, the interwoven point 208 is centrally located within the boundaries of the i-BCC unit cell 204. In other words, the illustrated interwoven point 208 is positioned at x, y, z coordinates of 0.5, 0.5, 0.5 (i.e., a “center point”) of the overall i-BCC unit cell 204. However, in other examples, the interwoven point 208 may be offset from an actual center of the i-BCC unit cell 204 (e.g., the x, y, z coordinates of the interwoven point 208 may differ from x, y, z coordinates of 0.5, 0.5, 0.5).

In the illustrated i-BCC unit cell 204, each of the first direction, second direction, third direction, and fourth direction extends away from the interwoven point 208 (e.g., perpendicularly from the corresponding diagonal unit cell plane P3, P4) and towards edges of the boundary of the i-BCC unit cell 204 (i.e., between the first ends 220a, 224a, 228a, 232a and second ends 220b, 224b, 228b, 232b). Stated differently, in the illustrated example, the first direction and the second direction (represented by the first distance D3 and the second distance D4, respectively, in FIG. 3B) are each coplanar with the second diagonal unit cell plane P4. The third direction and the fourth direction (represented by the third distance D5 and the fourth distance D6, respectively, in FIG. 3C) are each coplanar with the first diagonal unit cell plane P3. However, in other arrangements, the interwoven nodes 220c, 220b, 220c, 220d may be positioned in the i-BCC unit cell 204 with differing x, y, z coordinates such that this precise arrangement is not present.

With continued reference to FIGS. 3A-C, in the illustrated i-BCC unit cell 204, each of the first distance D3, the second distance D4, the third distance D5, and the fourth distance D6 are the same in length as measured from the interwoven point 208. In other examples, the lengths may not be equal. In some examples, any two of the first distance D3, the second distance D4, the third distance D5, and the fourth distance D6 may be the same. Additionally, in the illustrated example, the thickness D2 and each of the distances D3-D6 are dimensioned such that the interwoven nodes 220c, 224c, 228c, 232c do not intersect the interwoven point 208. The thickness D2 and each of the distances D3-D6 are also dimensioned such that the struts 220, 224, 228, 232 do not interfere with one another. In the illustrated example, the thickness D2 of each of the struts 220, 224, 228, 232 is the same, although in other examples the thickness one strut may be different than the thickness of another.

In the illustrated example, each of the first ends and second ends 220a, 224a, 228a, 232a, 220b, 224b, 228b, 232b terminates at a corner of the i-BCC unit cell 204. As such, the i-BCC unit cell 204 may be described as having boundary periodicity such that the i-BCC unit cell 204 may be duplicated in an array, with one i-BCC unit cell 204 being coupled to at least one adjacent i-BCC unit cell 204 such as in the i-BCC lattice structure 200 illustrated in FIG. 4.

Mathematically, the i-BCC unit cell 204 has several advantages over the BCC unit cell 104. In the context of Maxwell's criterion as generalized for three-dimensional structures, the BCC unit cell 104 has a count of states of self-stress less mechanisms (i.e., a “count”) which is a negative number (e.g., −13). For comparison, a just-rigid framework has a count of zero. Other bending dominated structures have counts which are negative. Interweaving the lattice has the effect of creating additional joints where the struts kink, while keeping the number of the struts the same. Thus, the count of the i-BCC unit cell 204 is an even larger negative number (e.g., −22). In other words, interwoven lattice structures include a greater number of available deformation mechanisms in comparison with their nodally coupled counterparts. This also indicates that interweaving a lattice has the effect of making the lattice more bending-dominated. This concept could be used to enhance deformability of even stiff, stretch dominated lattices, independent of the composition (e.g., material selection) of the base material.

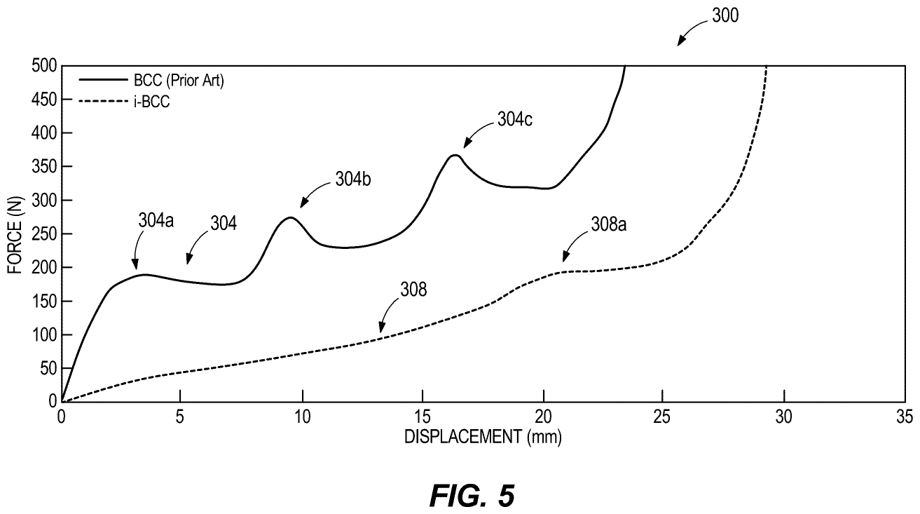

FIG. 5 illustrates a load displacement plot 300 of the BCC lattice structure 100 in comparison with the i-BCC lattice structure 200. To achieve the load displacement plot 300, a lattice structure was loaded into a testing machine, and a compression displacement rate was set. In the illustrated example, a compression displacement rate was set at 1 millimeter per second. However, other compression displacement rates are possible. Similar volume fractions of each lattice structure 100, 200 (e.g., 0.059 and 0.060, respectively), were tested. Still images of the lattice structure were taken throughout during compression, and a strain was calculated from the still images. Compliance of the loaded lattice structure was computed by using the inverse of the stiffness from the load displacement data. This still image and inverse stiffness testing method is one exemplary testing method to generate the load displacement plot 300. Other testing methods are possible.

The load displacement plot 300 includes a BCC load displacement curve 304 and an i-BCC load displacement curve 308. The BCC load displacement curve 304 includes a plurality of peaks 304a, 304b, 304c in loads applied as displacement was increased. As displacement was further increased beyond each of the peaks 304a, 304b, 304c, an internal force of the BCC lattice structure 100 decreased before increasing again to the next peak (e.g., 304b, 304c). Depending on the geometry (e.g., thickness D1) of the BCC lattice structure 100, different BCC load displacement curves 304 may be generated. Each peak 304a, 304b, 304c corresponds generally to a failure band of the BCC lattice structure 100. Failure bands of the BCC lattice structure 100 may correspond to a location where one row of BCC unit cells 104 interacts with another vertical row of BCC unit cells 104 during compression. In other words, failure bands may be located at an interface between adjacent BCC unit cells 104 in the compression direction of the BCC lattice structure 100.

The i-BCC load displacement curve 308 illustrates some advantages of the i-BCC lattice structure 200 over the BCC lattice structure 100. The i-BCC load displacement curve 308 is closer to the displacement axis (e.g., x axis) than the BCC load displacement curve 304. The i-BCC lattice structure 200 deflects more than the BCC lattice structure 100 for any applied load. In other words, the i-BCC lattice structure 200 is more compliant than the BCC lattice structure 100. The i-BCC load displacement curve 308 is smoother than the BCC load displacement curve 304. Smoothness of the i-BCC load displacement curve 308 is indicative that the i-BCC lattice structure 200 does not include similar failure bands as described above with regard to the BCC lattice structure 100. The i-BCC lattice structure 200 has demonstrated homogeneity of internal force distribution within struts thereof (e.g., 220, 224, 228, 232) upon compression. The i-BCC lattice structure 200 more evenly distributes loads (e.g., compressive forces) between the struts (e.g., 220, 224, 228, 232) in comparison with the BCC lattice structure 100, which includes sharp failure bands due to nonhomogeneous internal force distribution.

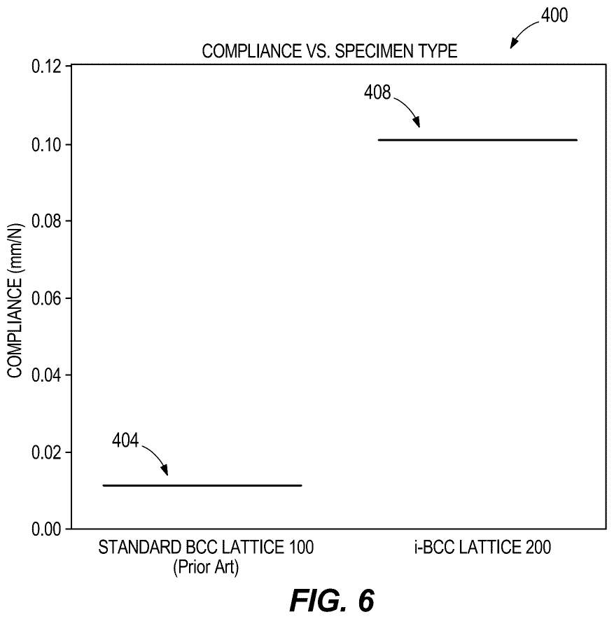

FIG. 6 illustrates a compliance chart 400 showing a difference in compliance between the BCC lattice structure 100 and the i-BCC lattice structure 200. A BCC compliance line 404 represents mean compliance of a plurality of test BCC lattice structures 100, and an i-BCC compliance line 408 represents mean compliance of a plurality of test i-BCC lattice structures 200. Mean compliance of the test BCC lattice structures 100 is approximately 0.01 millimeters per Newton. Mean compliance of the test i-BCC lattice structures 200 is approximately 0.10 millimeters per Newton. Stated differently, the i-BCC lattice structure 200 is approximately 10 times more compliant than the BCC lattice structure 100.

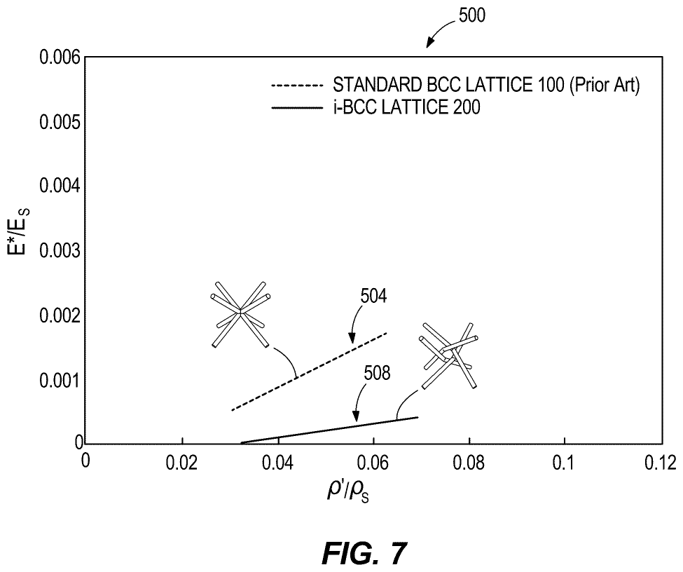

FIG. 7 illustrates a normalized effective modulus (E*/Eₛ) and relative density (ρ*/ρₛ) graph 500 (also known as an Ashby chart) comparing the BCC lattice structure 100 with the i-BCC lattice structure 200. Normalized effective modulus is the inverse measure of compliance. Relative density (also known as volume fraction) is a ratio of volume of a lattice structure in comparison with a solid unit cell with the same size as of the lattice structure unit cell. Relative density is influenced by at least the selected lattice shape (e.g., the BCC lattice structure and the i-BCC lattice structure have different relative densities) and thickness (e.g., an i-BCC lattice structure with a first thickness D2 has a different relative density compared to another i-BCC lattice structure with a different thickness).

The BCC lattice structure 100 is represented by a BCC force-displacement line 504, and the i-BCC lattice structure 200 is represented by an i-BCC force-displacement line 508. The i-BCC lattice structure 200 has a nominally lesser normalized effective modulus in comparison with the BCC lattice structure 100 of the same relative density. This is illustrated by the location of the i-BCC force-displacement line 508 being closer to the x-axis (e.g., the relative density axis) compared to the BCC force-displacement line 504. The slope of the i-BCC force-displacement line 508 is lesser than the slope of the BCC force-displacement line 504. Thus, for any increase in relative density of the i-BCC lattice structure 200, compliance decreases a lesser amount in comparison to a similar increase in relative density of the BCC lattice structure 100.

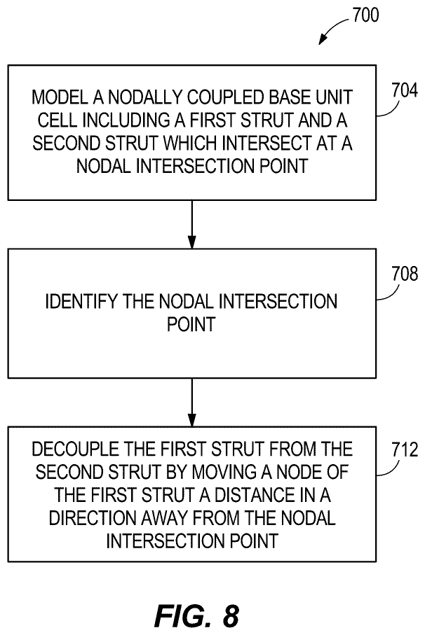

FIG. 8 illustrates a modeling procedure 700 for altering a nodally coupled base unit cell model to form a nodally decoupled unit cell model. The modeling procedure 700 includes a step 704 in which a nodally coupled base unit cell is modeled. The nodally coupled base unit cell includes at least a first strut and a second strut which intersect at a nodal intersection point. For example, the BCC unit cell 104 includes struts 120, 124, 128, 132 which intersect at the centroid 108. At step 708, the nodal intersection point is identified. For example, the centroid 108 of the BCC unit cell 104 is identified. At step 712, at least one node of at least one strut is moved in a direction away from the nodal intersection point. For example, the central point 120c of the strut 120 is moved away from the centroid 108 to a position corresponding with the first interwoven node 220c illustrated in the i-BCC unit cell 204 (FIGS. 3A, 3B).

The modeling procedure 700 may include further steps. For example, the modeling procedure 700 may identify at least one modeling plane (e.g., the diagonal unit cell planes P1-P4). This modeling plane may be utilized to orient the direction of movement of the node of the at least one strut which is moved. The modeling plane may also be utilized to orient the direction of movement of any other nodes which are moved relative to the nodal intersection point (e.g., the centroid 108). For example, in altering the BCC unit cell 104 to model the i-BCC unit cell 204, diagonal unit cell planes P1, P2 are identified. The central point 120c of the strut 120 is moved away from the centroid 108 a first distance (e.g., distance D3) in a direction (e.g., a 90-degree angle relative to) the first diagonal unit cell plane P1 to a position corresponding with the first interwoven node 220c illustrated in the i-BCC unit cell 204. As with the diagonal unit cell planes P1, P2, the modeling plane may be oriented relative to the unit cell U itself. Alternately, the modeling plane may be oriented relative to one or mode nodes of the base BCC unit cell 104. In other examples, the direction of movement of the node may be along the modeling plane, or at any desired angle relative to the modeling plane.

The modeling procedure 700 may further include moving a node of the second strut a second distance in a second direction away from the nodal intersection point. For example, the central point 124c of the strut 124 may be moved a distance D4 away from the centroid 108. The second direction may oppose the first direction. For example, in the illustrated example, the direction of movement of the central point 124c to the position of the interwoven node 124c from the centroid 108 opposes the direction of movement of the central point 120c to the position of the interwoven node 120c from the centroid 108. However, in other examples, the directionality of the first direction and the second direction may differ. In the illustrated example, the first distance D3 and the second distance D4 are the same. However, in other examples, the distances D3, D4, may differ.

The modeling procedure 700 may further include identifying more than one nodal intersection point (e.g., two, three, four, or more nodal intersection points per unit cell), and moving at least one node away from each of the more than one nodal intersection point.

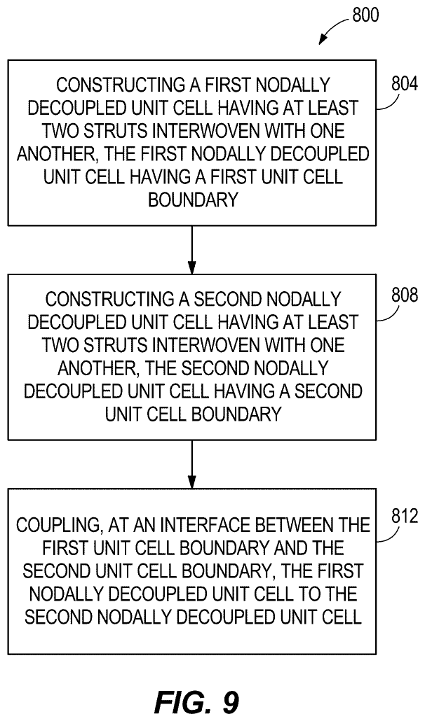

FIG. 9 illustrates a manufacturing procedure 800 for constructing an interwoven lattice structure. The manufacturing procedure 800 includes a step 804 in which a first nodally decoupled unit cell (e.g., a first instance of the i-BCC unit cell 204) is constructed. The first nodally decoupled unit cell includes at least two struts which are interwoven with one another. The first decoupled unit cell has a first unit cell boundary (e.g., at the edges of the unit cell U). At step 808, a second nodally decoupled unit cell (e.g., a second instance of the i-BCC unit cell 204) is constructed. The second nodally decoupled unit cell includes at least two struts which are interwoven with one another. The second decoupled unit cell has a second unit cell boundary (e.g., at the edges of the unit cell U). At step 812, the first decoupled unit cell and the second decoupled unit cell are coupled at an interface between the first unit cell boundary and the second unit cell boundary. In some examples, the first nodally decoupled unit cell and the second nodally decoupled unit cell have the same shape.

In some examples, the first decoupled unit cell and the second decoupled unit cell include boundary periodicity such that the manufacturing procedure 800 may be duplicated in an array (e.g., three-dimensional grid) to form a nodally decoupled lattice (e.g., the i-BCC lattice structure 200). In instances where one of the first decoupled unit cell and the second decoupled unit cell is does not include boundary periodicity, modifications may be made to the manufacturing procedure 800 to account for the boundary incontinuity. Such modifications may include modeling and/or manufacturing a hybridized unit cell structure including at least one nodally decoupled unit cell (e.g., an interwoven Face Centered Cubic T-FCC unit cell) and at least one different unit cell structure (e.g., i-BCC unit cell).

In some examples (e.g., the i-BCC lattice structure 200), each of the first nodally decoupled unit cell and the second nodally decoupled unit cell may include four struts (e.g., 220, 224, 228, 232). At least three of those four struts 220, 224, 228, 232 include a node (e.g., three of 220c, 224c, 228c, 232c) spaced from an interwoven point 208. Optionally, each of the four struts 220, 224, 228, 232 may include a node (each of 220c, 224c, 228c, 232c) spaced from the interwoven point 208.

The manufacturing procedure 800 may simultaneously conduct each of steps 804, 808, and 812. In other words, each of the first nodally decoupled unit cell and the second nodally decoupled unit cell may be constructed simultaneously. Further, simultaneously with construction of the first nodally decoupled unit cell and the second nodally decoupled unit cell, the first and second nodally decoupled unit cells may be coupled. In some examples, the manufacturing procedure 800 involves construction of the first nodally decoupled unit cell and the second nodally decoupled unit cell by an additive manufacturing process. Optionally, coupling of the first nodally decoupled unit cell and the second nodally decoupled unit cell may also be conducted by the same or a further (e.g., sequential) additive manufacturing process.

The manufacturing procedure 800 may further comprise coupling at least one of the first nodally decoupled unit cell and the second nodally decoupled unit cell to a support. Such a support may spread loads (e.g., compressive, tensile) throughout the nodally decoupled lattice (e.g., i-BCC lattice structure 200).

The manufacturing procedure 800 relates to construction of an interwoven lattice structure (e.g., the i-BCC lattice structure 200) including a plurality of interwoven unit cells (e.g., a plurality of i-BCC unit cells 204). However, in some examples, only a single unit cell (e.g., only a single i-BCC unit cell 204) may be manufactured.

The modeling procedure 700 may be conducted, for example, on computer aided drafting software. The manufacturing procedure 800 may be conducted, for example, by an additive manufacturing machine such as, without limitation, a conventional 3-D printer. The manufacturing procedure 800 may be conducted based on the interwoven model generated by the modeling procedure 700. Alternately, the manufacturing procedure 800 may be conducted based on a known interwoven model. Further, the manufacturing procedure 800 need not be based on additive manufacturing (e.g., 3-D printing). For example, physical nodes of physical struts may be decoupled in accordance with the modeling procedure 700 during the manufacturing procedure 800.

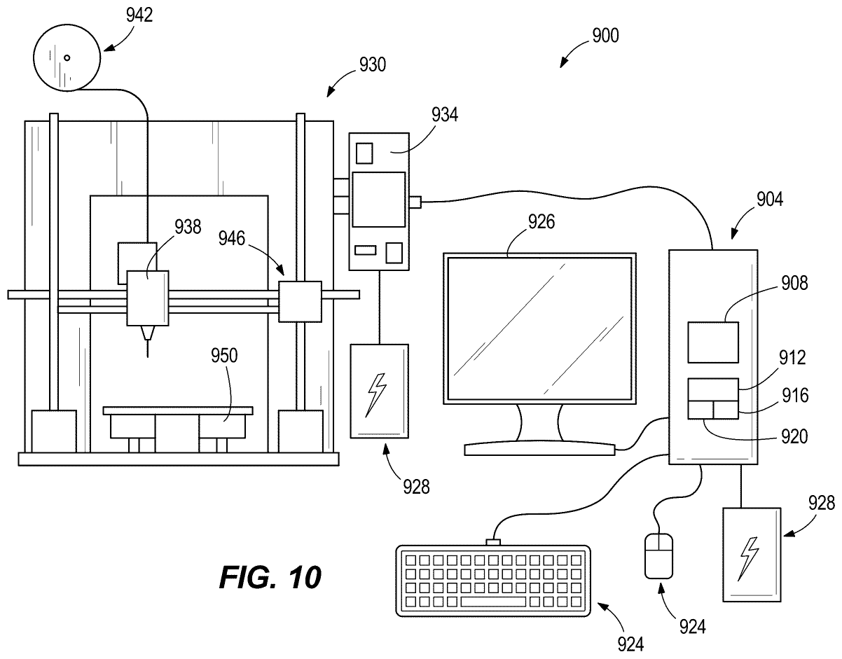

FIG. 10 illustrates an additive manufacturing system 900 including a computer 904 and an additive manufacturing machine 930. The computer 904 includes a processor 908, a non-transitory memory 912 including a modeling software program 916 and a library 920 of stored base unit cell structures and/or nodally decoupled unit cell structures. The computer 904 is optionally coupled to one or more input devices (e.g., a mouse, keyboard) 924 to facilitate user-interaction with the computer 904. The computer 904 is optionally coupled to a display device 926 (e.g., a monitor) to facilitate displaying data to a user. The display device 926 may display data relating to the modeling procedure 700 and/or the manufacturing procedure 800. The computer 904 is be coupled to a power source 928. The power source 928 may be an external power source such as alternating current mains electricity.

The additive manufacturing machine 930 includes a processor 934, working element 938, additive material supply 942, conveyor system 946, and hot bed 950. The additive manufacturing machine 930 is coupled to a power source 928. In some embodiments, the working element 938 may be an extruder configured to extrude layers of additive material. In other embodiments, the working element 938 may include, without limitation, a laser, binder jet, or the like. The power source 928 may be an external power source such as alternating current mains electricity. Optionally, power from the computer 904 may be transmitted to the additive manufacturing machine 930. The processor 934 is configured to receive a signal from the computer 904, and to operate the working element 938, and in some instances, the conveyor system 946 to lay additive material and/or a binding material in a desired geometry from the additive material supply 942. In some instances, the additive material and/or binding material may be deposited onto the hot bed 950. In other instances, additive material such as powder, may be melted by lasers in a support-free manufacturing process.

During operation of the additive manufacturing system 900, the computer 904 is used to generate a nodally decoupled lattice geometry, and the additive manufacturing machine 930 is used to construct the nodally decoupled lattice. By following the modeling procedure 700, the user may operate the user input device 924 to provide input data to the modeling software program 916 to alter a nodally coupled base unit cell from the library 920 to a nodally decoupled base unit cell. The nodally decoupled base unit cell may be saved to the library 920 and duplicated by the modeling software program 916 and processor 908 to create the desired lattice geometry. One or more signals of this desired lattice geometry are sent from the computer 904 to the additive manufacturing machine 930, and the additive manufacturing machine 930 operates the extruder 938 and conveyor system 946 to lay additive material in the desired lattice geometry from the additive material supply 942 onto the hot bed 950.

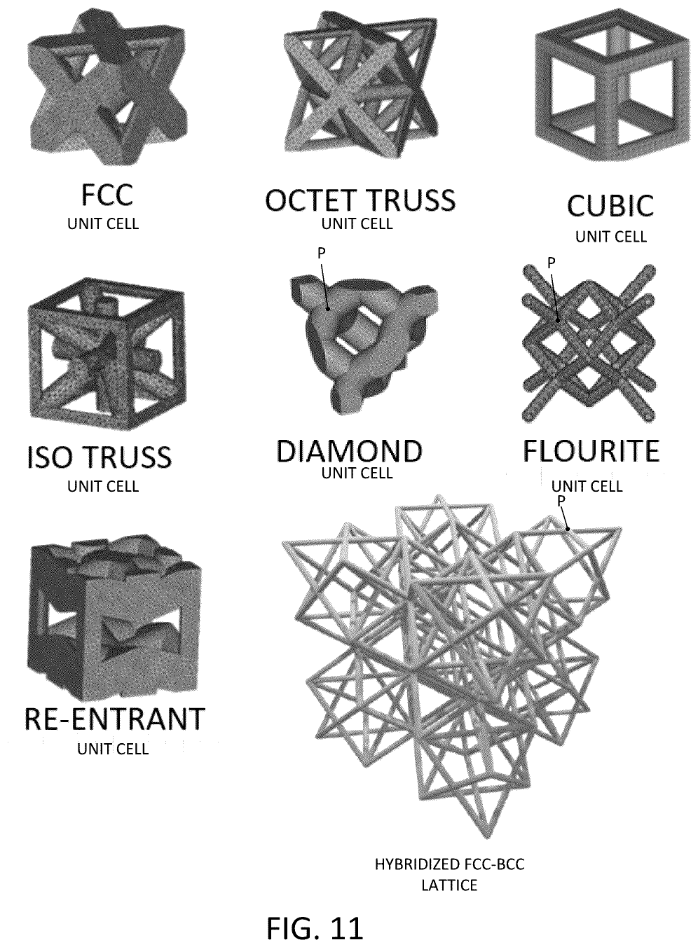

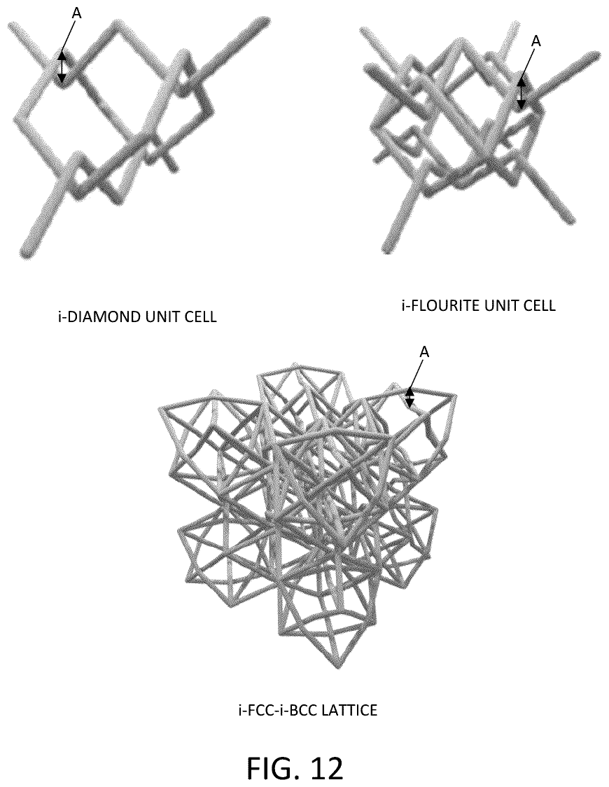

While the description above relates generally to the i-BCC lattice structure 200, the modeling procedure 700, manufacturing procedure 800, and operation of the additive manufacturing system 900 may be altered to construct various different interwoven unit cells and lattices. For example, FIG. 11 illustrates a plurality of different nodally coupled unit cells such as diamond, fluorite, cubic, iso truss, re-entrant, and octet truss. FIG. 11 further illustrates a hybridized and nodally coupled BCC-FCC lattice. For example, the diamond unit cell, fluorite unit cell, and hybridized FCC-BCC lattice are illustrated with points P which generally correspond with the aforementioned centroid 108 of the BCC unit cell 104, and which provide a nodal intersection point. Such nodally coupled cells may be altered in accordance with the modeling procedure 700 and/or manufacturing procedure 800 to model and/or construct an interwoven diamond (FIG. 12), interwoven fluorite (FIG. 12), hybridized i-BCC and interwoven face centered cubic lattice (FIG. 12). Arrows A illustrated in FIG. 12 illustrate the nodal decoupling of these structures in a similar manner to the distances D3-D6 of the i-BCC unit cell 204. Additional exemplary interwoven unit cells not illustrated in the figures may include but are not limited to interwoven octet trusses, interwoven cubic cells, interwoven iso trusses, and interwoven re-entrant cells.

The aforementioned modeling procedure 700 and manufacturing procedure 800 may be used to form differing lattice structures including both coupled nodes (e.g., the centroid 108 of the BCC lattice structure 100) and decoupled nodes (e.g., the interwoven point 208 of the i-BCC lattice structure 200). The quantity and location of coupled nodes and decoupled nodes may be selected to tune compliance to a desired value.

Amounts of improvement in compliance depend on factors such as the geometry of the interwoven lattice, thickness thereof, and the size of the unit cell. However, of the interwoven geometries tested, each interwoven geometry has improved compliance in comparison with similar volume fraction nodally coupled geometries. For reference, the diamond unit cell has a count of states of self-stress less mechanisms (i.e., “count”) of −20, the interwoven diamond unit cell has a count of −32. The fluorite unit cell has a count of −28, the interwoven diamond unit cell has a count of −52. The interwoven diamond unit cell was found to be approximately 5.3 times more compliant than the standard diamond unit cell. The interwoven fluorite unit cell was found to be approximately 4.4 times more compliant than the standard fluorite unit cell. Finally, the interwoven BCC-FCC lattice structure was found to be approximately 13.5 times more compliant than the standard BCC-FCC lattice structure.

The proposed modeling procedure 700 and manufacturing procedure 800 construct interwoven lattices (e.g., the i-BCC lattice structure 200) without the need for high-resolution additive manufacturing machines (which are required to generate braided struts). Conventional additive manufacturing machines 930 may be used to create interwoven lattices using known processes such as fused deposition modeling, stereolithography, selective laser sintering, binder jetting and laser powder bed fusion. Thus, interwoven lattices are more easily manufacturable at scale.

Such interwoven lattices may be applicable in various compliant material applications such as piezoelectric sensing for wearables and biomedical devices, energy absorbers, vibration damping, sporting goods, space debris protection, armor, and other applications where high compliance is sought at large relative densities.

Various features of the disclosure are set forth in the following claims.

What is claimed is:

1. A unit cell of an interwoven lattice structure, the unit cell having an interwoven point therein, the unit cell comprising:
a first strut having a first interwoven node offset from a first diagonal unit cell plane by a first distance in a first direction perpendicular to the first diagonal unit cell plane;
a second strut having a second interwoven node offset from the first diagonal unit cell plane by a second distance in a second direction opposite to the first direction;
a third strut having a third interwoven node offset from a second diagonal unit cell plane by a third distance in a third direction perpendicular to the second diagonal unit cell plane, the second diagonal unit cell plane being perpendicular to the first diagonal unit cell plane; and
a fourth strut having a fourth interwoven node offset from the second diagonal unit cell plane by a fourth distance in a fourth direction opposite to the third direction,
wherein each of the first interwoven node, second interwoven node, third interwoven node, and the fourth interwoven node are offset from the interwoven point of the unit cell, and
wherein the first diagonal unit cell plane and the second diagonal unit cell plane both pass through the interwoven point.

2. The unit cell of claim 1, wherein the first strut includes a first end node positioned at a first corner of the unit cell and a second end node positioned at a second corner of the unit cell, the second corner being opposite the first corner.

3. The unit cell of claim 1, wherein the first distance and the second distance are the same.

4. The unit cell of claim 1, wherein each of the first strut, second strut, third strut, and fourth strut includes a thickness less than each of the first distance, the second distance, the third distance, and the fourth distance, such that none of the first strut, second strut, third strut, and fourth strut intersect the interwoven point.

5. The unit cell of claim 4, wherein the thickness of the first strut is equal to the thickness of the second strut, the third strut, and the fourth strut.

6. The unit cell of claim 1, wherein the unit cell has a center point, and the interwoven point is positioned at the center point.

7. The unit cell of claim 1, wherein the first interwoven node, the second interwoven node, the third interwoven node, and the fourth interwoven node are each spaced apart from one another.

8. A method of altering a nodally coupled base unit cell model to model a nodally decoupled unit cell model, the method comprising:
modelling the nodally coupled base unit cell, the base unit cell including a first strut and a second strut which intersect at a nodal intersection point;
identifying the nodal intersection point;
decoupling the first strut from the second strut by moving a node of the first strut a first distance in a first direction away from the nodal intersection point.

9. The method of claim 8, further comprising moving a node of the second strut a second distance in a second direction away from the nodal intersection point.

10. The method of claim 9, wherein the second direction is opposite the first direction.

11. The method of claim 9, wherein the first distance is equal to the second distance.

12. The method of claim 8, wherein the nodally coupled base unit cell model is a body center cubic unit cell structure including four struts intersecting at the nodal intersection point, and the nodally decoupled unit cell model is an interwoven body center cubic unit cell model including four struts each having a node spaced from the nodal intersection point.

13. The method of claim 8, wherein the nodally decoupled unit cell model includes a greater number of deformation mechanisms when compared to the nodally coupled base unit cell model.

14. A method for manufacturing an interwoven lattice structure, the method comprising:
constructing a first nodally decoupled unit cell having at least two struts interwoven with one another, the first nodally decoupled unit cell having a first unit cell boundary,
constructing a second nodally decoupled unit cell having at least two struts interwoven with one another, the second nodally decoupled unit cell having a second unit cell boundary,
coupling, at an interface between the first unit cell boundary and the second unit cell boundary, the first nodally decoupled unit cell to the second nodally decoupled unit cell.

15. The method of claim 14, wherein the first nodally decoupled unit cell has four struts each having a node spaced from an interwoven node.

16. The method of claim 14, wherein the first nodally decoupled unit cell and the second nodally decoupled unit cell are constructed simultaneously.

17. The method of claim 14, wherein at least one of the first nodally decoupled unit cell and the second nodally decoupled unit cell is constructed by an additive manufacturing process.

18. The method of claim 14, further comprising coupling at least one of the first nodally decoupled unit cell and the second nodally decoupled unit cell to a support.

19. The method of claim 14, wherein the first nodally decoupled unit cell is a hybridized unit cell structure including at least one nodally decoupled unit cell and at least one different unit cell structure.

20. The method of claim 14, wherein the first nodally decoupled unit cell and the second nodally decoupled unit cell have the same shape.
